(19) United States
(12) Patent Application Publication
(10) Pub. No.: US 2022/0105556 A1
(43) Pub. Date: Apr. 7, 2022

(54) FRAME MANUFACTURING METHOD

(71) Applicant: TOYOTA JIDOSHA KABUSHIKI KAISHA, Toyota-shi (JP)

(72) Inventors: Tatsuyuki HAYASHI, Toyota-shi (JP); Hiroshi KIMPARA, Miyoshi-shi (JP)

(73) Assignee: TOYOTA JIDOSHA KABUSHIKI KAISHA, Toyota-shi (JP)

(21) Appl. No.: 17/465,538

(22) Filed: Sep. 2, 2021

(30) Foreign Application Priority Data
Oct. 5, 2020 (JP) 2020-168587

(51) Int. Cl. B21D 51/06; B21D 53/88

(52) U.S. Cl. CPC B21D 51/06; B21D 53/88

(57) ABSTRACT

A technique for improving durability of a frame is provided. A method for manufacturing a honeycomb structure from a triangular hollow pipe composed of a first flat plate, a second flat plate, and a third flat plate includes forming a first slit in the hollow pipe so as to cut all the flat plates except the first plate and forming a second slit in the hollow pipe at a position different from a position of the first slit position in a longitudinal direction of the hollow pipe so as to cut all the flat plates except the second flat plate and folding back the first plate at the first slit position and folding back the second flat plate at the position of the second slit position.

### CROSS REFERENCE TO RELATED APPLICATIONS

This application is based upon and claims the benefit of priority from Japanese patent application No. 2020-168587, filed on Oct. 5, 2020, the disclosure of which is incorporated herein in its entirety by reference.

### BACKGROUND

The present disclosure relates to a method for manufacturing a frame.

Published Japanese Translation of PCT International Publication for Patent Application, No. 2017-519663 discloses a honeycomb core structure composed of metallic triangular honeycomb cores arranged regularly. A connecting layer formed by forming glass fibers into a mat is disposed between the two honeycomb cores. An adhesive is applied to both sides of the connecting layer to allow the connecting layer to connect the two honeycomb cores.

### SUMMARY

However, the honeycomb core structure of Published Japanese Translation of PCT International Publication for Patent Application, No. 2017-519663 could be further improved in terms of durability.

An object of the present disclosure is to provide a technique for improving durability of a frame.

An example aspect of the present disclosure is a method for manufacturing a frame from an N-polygonal shape (N is a natural number greater than or equal to 3) hollow pipe composed of first to N-th flat plates. The method includes: forming a first slit in the hollow pipe so as to cut all the flat plates except the first plate and forming a second slit in the hollow pipe at a position different from a position of the first slit in a longitudinal direction of the hollow pipe so as to cut all the flat plates except the second flat plate; and folding back the first plate at the position of the first slit and folding back the second flat plate at the position of the second slit. According to the above method, it is possible to improve durability

Preferably, the N is 3, and the hollow pipe is triangular.

Preferably, the above method further includes forming a third slit in the hollow pipe so as to cut all the flat plates except the third flat plate at a position different from the position of the first slit and the position of the second slit in the longitudinal direction, and folding back the third flat plate at the position of the third slit. According to the above method, a frame extending in a straight line is implemented.

Preferably, the N is 4, and the hollow pipe is quadrangular.

Preferably, the first flat plate and the second flat plate face each other across an internal space of the hollow pipe. According to the above method, a frame extending in a straight line is implemented.

Preferably, the above method further includes: forming a third slit in the hollow pipe so as to cut all the flat plates except the first flat plate at a position different from the position of the first slit and the position of the second slit in the longitudinal direction; and folding back the first flat plate at the position of the third slit. According to the above method, a large frame extending in a straight line is implemented.

Preferably, the hollow pipe is rectangular.

Preferably, the hollow pipe has a trapezoidal shape. The first flat plate and the second flat plate correspond to legs of the hollow pipe. According to the above method, an arched frame is implemented.

Preferably, the hollow pipe is an isosceles trapezoid.

Preferably, the hollow pipe is made of metal or resin.

Preferably, the frame is a strength part, a suspension part of an automobile, a chassis part, or a ladder frame.

According to the present disclosure, it is possible to improve durability of a frame.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view of a honeycomb structure (first embodiment);

FIG. 2 is a perspective view of a honeycomb core (first embodiment);

FIG. 3 is a manufacturing flow of the honeycomb structure (first embodiment);

FIG. 4 is a perspective view of a hollow pipe (first embodiment);

FIG. 5 is a perspective view of the hollow pipe with slits formed therein (first embodiment);

FIG. 6 is a perspective view of the hollow pipe with slits formed therein (first embodiment);

FIG. 7 is a perspective view showing a hollow pipe with slits formed therein being bent (first embodiment);

FIG. 8 shows a honeycomb core according to a first modified example (first embodiment);

FIG. 9 shows a honeycomb core according to a second modified example (first embodiment);

FIG. 10 is a perspective view of a honeycomb core (second embodiment);

FIG. 11 is a perspective view of a hollow pipe (second embodiment);

FIG. 12 is a perspective view of the hollow pipe with slits formed therein (second embodiment);

FIG. 13 is a perspective view showing a hollow pipe with slits formed therein being bent (second embodiment);

FIG. 14 shows a front view of a kickback frame with a honeycomb structure applied (second embodiment);

FIG. 15 is a perspective view of a hollow pipe with slits formed therein (third embodiment); and

FIG. 16 is a front view of a honeycomb core (third embodiment).

### DESCRIPTION OF EMBODIMENTS

### First Embodiment

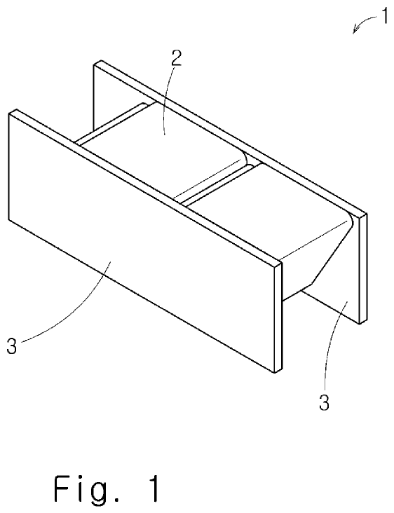

A first embodiment will be described below with reference to FIGS. 1 to 7. FIG. 1 is a perspective view of a honeycomb structure 1. As shown in FIG. 1, the honeycomb structure 1 includes a honeycomb core 2 and two top plates 3 sandwiching the honeycomb core 2. The honeycomb structure 1 is a specific example of a frame. The honeycomb structure 1 (frame) can be used as a strength member for enhancing the strength. For example, the honeycomb structure 1 (frame) can be applied to suspension parts and chassis parts of an automobile. The honeycomb structure 1 (frame) can also be used as a ladder frame. Therefore, a method for manufacturing a frame, which will be described later, may be regarded as a method for manufacturing a strength part, a suspension part, a chassis part, a ladder frame, or the like.

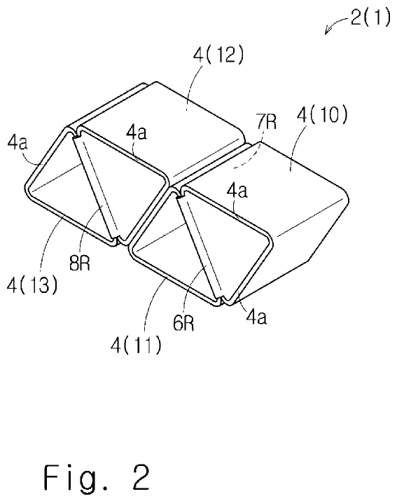

FIG. 2 is a perspective view of the honeycomb core 2. As shown in FIG. 2, in this embodiment, the honeycomb core 2 is formed by stacking core elements 4, which are triangular short hollow pipes, in a direction orthogonal to a longitudinal direction of the core elements 4.

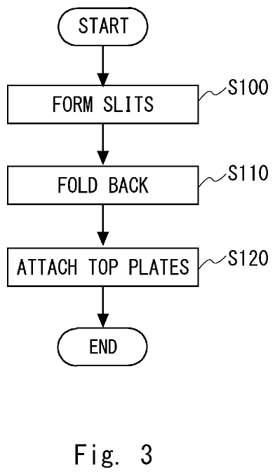

FIG. 3 shows a manufacturing flow of the honeycomb structure 1. The manufacture of the honeycomb structure 1 will be described below along the manufacturing flow of FIG. 3.

### S100: Forming Slits

FIG. 4 is a perspective view of a triangular long hollow pipe 5. The hollow pipe 5 is, for example, a welded pipe made of metal such as stainless steel, aluminum alloy, titanium alloy, etc. or resin, and a cross section of the hollow pipe 5 has a hollow triangular shape. The hollow pipe 5 includes a first flat plate 6, a second flat plate 7, and a third flat plate 8. The first flat plate 6, the second flat plate 7, and the third flat plate 8 are arranged in such a way that each flat plate corresponds to each side of an equilateral triangle. The first flat plate 6, the second flat plate 7, and the third flat plate 8 are connected to each other at vertexes of the equilateral triangle. The plate thickness of the hollow pipe 5, that is, the plate thickness of the first flat plate 6, the second flat plate 7, and the third flat plate 8, is, for example, 1 to 3 millimeters, but is not limited to this.

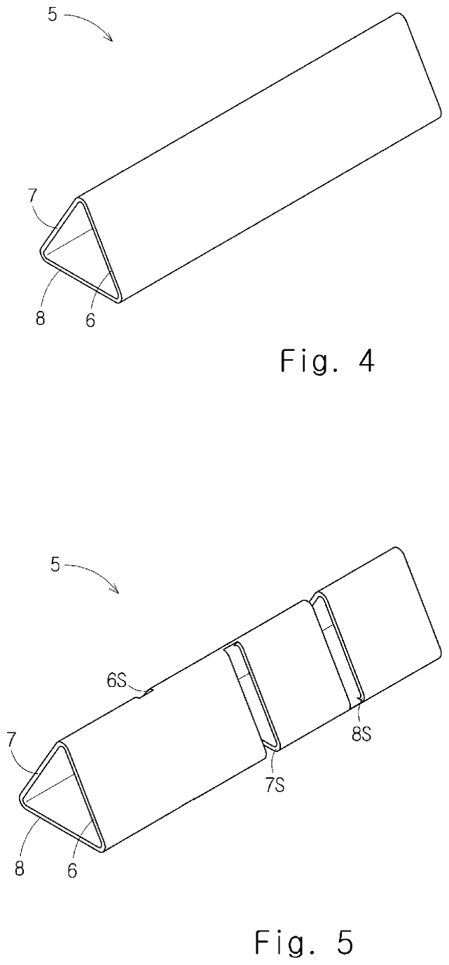

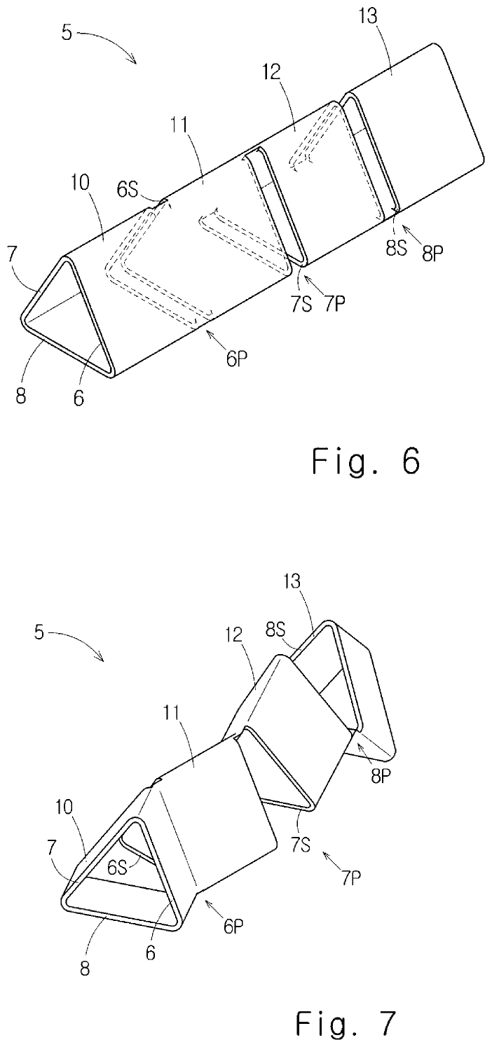

FIGS. 5 and 6 show the hollow pipe 5 in which a first slit 6S, a second slit 7S, and a third slit 8S are formed.

As shown in FIGS. 5 and 6, the first slit 6S, the second slit 7S, and the third slit 8S are formed at different positions in the longitudinal direction of the hollow pipe 5.

As shown in FIG. 6, in the longitudinal direction of the hollow pipe 5, the position where the first slit 6S is formed is defined as a first slit position 6P, the position where the second slit 7S is formed is defined as a second slit position 7P, and the position where the third slit 8S is formed is defined as a third slit position 8P.

The first slit 6S, the second slit 7S, and the third slit 8S are formed in this order in the longitudinal direction of the hollow pipe 5. The first slit 6S, the second slit 7S, and the third slit 8S are formed so as to divide the hollow pipe 5 into four equal parts in the longitudinal direction of the hollow pipe 5.

The first slit 6S is formed in the second flat plate 7 and the third flat plate 8 so as to completely cut all the flat plates except the first flat plate 6, i.e., the second flat plate 7 and the third flat plate 8. The first slit 6S is formed to extend in a direction orthogonal to the longitudinal direction of the hollow pipe 5. The first slit 6S is formed to extend in a V shape when viewed in the longitudinal direction of the hollow pipe 5. A slit width of the first slit 6S is typically twice the plate thickness of the hollow pipe 5. However, the slit width of the first slit 6S may be larger than twice the plate thickness of the hollow pipe 5 or as small as possible.

The second slit 7S is formed in the first flat plate 6 and the third flat plate 8 so as to completely cut all the flat plates except the second flat plate 7, that is, the first flat plate 6 and the third flat plate 8. The second slit 7S is formed to extend in a direction orthogonal to the longitudinal direction of the hollow pipe 5. The second slit 7S is formed to extend in a V shape when viewed in the longitudinal direction of the hollow pipe 5. A slit width of the second slit 7S is typically twice the plate thickness of the hollow pipe 5. However, the slit width of the second slit 7S may be larger than twice the plate thickness of the hollow pipe 5 or as small as possible.

The third slit 8S is formed in the first flat plate 6 and the second flat plate 7 so as to completely cut all the flat plates except the third flat plate 8, that is, the first flat plate 6 and the second flat plate 7. The third slit 8S is formed to extend in a direction orthogonal to the longitudinal direction of the hollow pipe 5. The third slit 8S is formed to extend in a V shape when viewed in the longitudinal direction of the hollow pipe 5. A slit width of the third slit 8S is typically twice the plate thickness of the hollow pipe 5. However, the slit width of the third slit 8S may be larger than twice the plate thickness of the hollow pipe 5 or as small as possible.

By forming the first slit 6S, the second slit 7S and the third slit 8S in the hollow pipe 5 in this manner, the hollow pipe 5 is divided into a first core element 10, a second core element 11, a third core element 12, and a fourth core element 13 in the longitudinal direction of the hollow pipe 5.

The first core element 10 and the second core element 11 are divided by the first slit 6S and are connected to each other with the first flat plate 6 interposed therebetween. The second core element 11 and the third core element 12 are divided by the second slit 7S and are connected to each other with the second flat plate 7 interposed therebetween. The third core element 12 and the fourth core element 13 are divided by the third slit 8S and are connected to each other with the third flat plate 8 interposed therebetween.

### S110: Folding Back

FIG. 7 shows a state in which the first flat plate 6, the second flat plate 7, and the third flat plate 8 of the hollow pipe 5 are being folded back.

As shown in FIGS. 2 and 7, the first flat plate 6 is folded back at the first slit position 6P. That is, the first flat plate 6 is folded back by 180 degrees at the first slit position 6P in a direction in which the slit width of the first slit 6S expands. Similarly, the second flat plate 7 is folded back at the second slit position 7P. That is, the second flat plate 7 is folded back by 180 degrees at the second slit position 7P in a direction in which the slit width of the second slit 7S expands. Similarly, the third flat plate 8 is folded back at the third slit position 8P. That is, the third flat plate 8 is folded back by 180 degrees at the third slit position 8P in a direction in which the slit width of the third slit 8S expands.

As a result, as shown in FIG. 2, the adjacent core elements 4 are connected to each other by the base material itself of the hollow pipe 5. That is, the first core element 10 and the second core element 11 are connected to each other with a first curved part 6R interposed therebetween, in which the first curved part 6R is formed by bending the first flat plate 6 in a U-shape at the first slit position 6P. The second core element 11 and the third core element 12 are connected to each other with a second curved part 7R interposed therebetween, in which the second curved part 7R is formed by bending the second flat plate 7 in a U-shape at the second slit position 7P. The third core element 12 and the fourth core element 13 are connected to each other with a third curved part 8R interposed therebetween, in which the third curved part 8R is formed by bending the third flat plate 8 in a U-shape at the third slit position 8P. Therefore, as compared with the case where the adjacent core elements 4 are connected by an adhesive, large bonding strength of the adjacent core elements 4 can be ensured. Adhesives are inferior to metals in water resistance and heat resistance. Thus, when the hollow pipe 5 is made of metal, the honeycomb core 2 excellent in the water resistance and the heat resistance is implemented by connecting the adjacent core elements 4 by the base material itself of the hollow pipe 5.

Further, as shown in FIGS. 5 to 7, by forming the first slit 6S, the second slit 7S, and the third slit 8S in the longitudinal direction of the hollow pipe 5 in this order, the honeycomb core 2 in which the plurality of core elements 4 are arranged in a straight line is implemented as shown in FIG. 2. The honeycomb core 2 shown in FIG. 2 can be made larger by repeatedly forming the first slit 6S, the second slit 7S, and the third slit 8S in this order in the hollow pipe 5 which is longer than the hollow pipe 5 shown in FIG. 4.

As shown in FIG. 2, by making the lengths of the core elements 4 equal to each other, the cut surfaces of the core elements 4 are located in the same plane.

### S120: Attaching Top Plates

Next, as shown in FIG. 1, the two top plates 3 are attached to the honeycomb core 2 so as to sandwich the honeycomb core 2 between the two top plates 3. Specifically, each top plate 3 is attached to a cut surface 4a of each core element 4 by brazing, laser welding, or arc welding. By doing so, the honeycomb structure 1 is completed. If there is no moisture in the environment in which the honeycomb structure 1 is used, the top plates 3 may be attached to the cut surfaces 4a of the core elements 4 with an adhesive.

Since the honeycomb structure 1 shown in FIG. 1 is lightweight and highly rigid, it can be applied to various beams including columns of a vehicle, but the present disclosure is not limited to this.

The first embodiment has been described above. The above embodiment has the following features.

The method for manufacturing the honeycomb structure 1 (frame) from the triangular hollow pipe 5 composed of the first flat plate 6, the second flat plate 7, and the third flat plate 8 includes the following steps.

As shown in FIGS. 5 and 6, the method for manufacturing the honeycomb structure 1 includes a step of forming the first slit 6S in the hollow pipe 5 so as to cut all the flat plates except the first flat plate 6 (i.e., the second plate 7 and third plate 8), and forming the second slit 7S in the hollow pipe 5 so as to cut all the flat plates except the second flat plate 7 (i.e., the first plate 6 and the third plate 8) at the position different from the first slit position 6P (the position of the first slit) in the longitudinal direction of the hollow pipe 5.

The method for manufacturing the honeycomb structure 1 further includes a step of folding back the first flat plate 6 at the first slit position 6P, and folding back the second flat plate 7 at the second slit position 7P (the position of the second slit).

According to the above method, since the plurality of core elements 4 divided by the first slit 6S and the second slit 7S are connected to each other by the base material itself of the hollow pipe 5, the honeycomb structure 1 excellent in the water resistance and the heat resistance is implemented as compared with the case where the core elements 4 are connected to each other by an adhesive.

In the step of forming slits, the third slit 8S is further formed in the hollow pipe 5 at the position different from the first slit position 6P and the second slit position 7P in the longitudinal direction so as to cut all the flat plates except the third flat plate 8 (i.e., the first plate 6 and the second plate 7). In the step of folding back, the third flat plate 8 is further folded back at the third slit position 8P (the position of the third slit). According to the above method, as shown in FIG. 2, the honeycomb structure 1 in which the plurality of core elements 4 divided by the first slit 6S, the second slit 7S, and the third slit 8S are arranged in a straight line is implemented.

The first embodiment can be changed as follows.

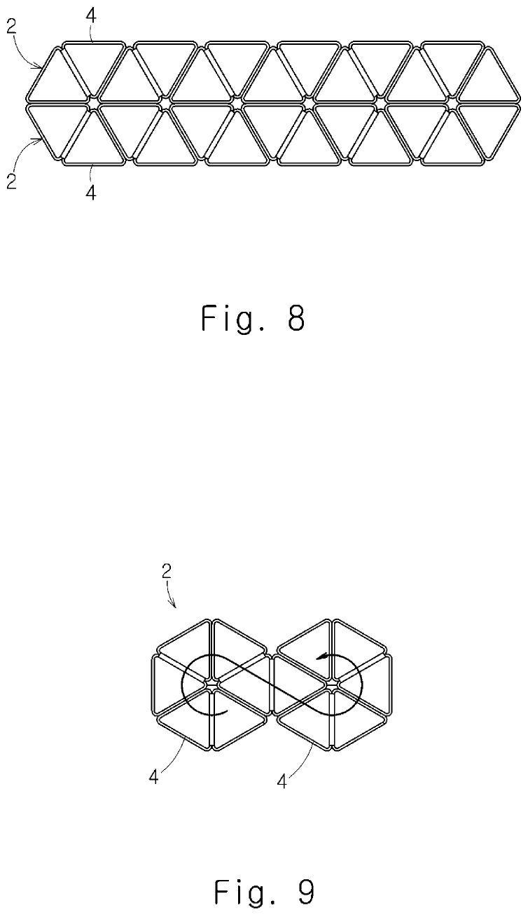

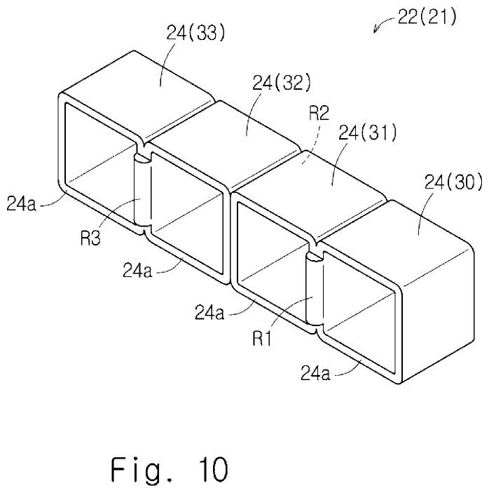

For example, as shown in FIG. 8, the honeycomb cores 2 formed by arranging the plurality of core elements 4 in a straight line may be stacked. Further, as shown in FIG. 9, the plurality of core elements 4 may be arranged along an arc to form a honeycomb core 2 having a pseudo hexagonal shape. In the example shown in FIG. 9, the plurality of core elements 4 are arranged along an S-shape, thereby achieving two adjacent honeycomb cores 2 each having a pseudo hexagonal shape.

### Second Embodiment

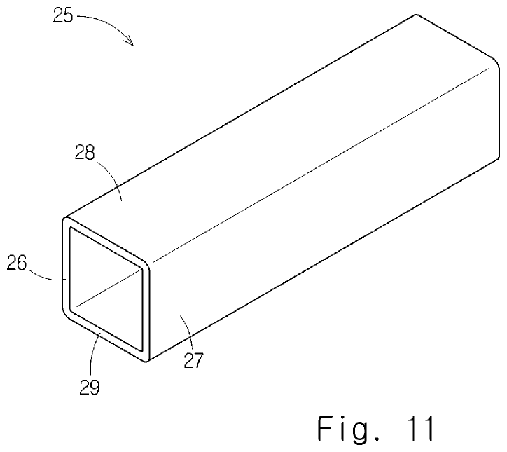

Next, a second embodiment will be described with reference to FIGS. 10 to 14. Hereinafter, this embodiment will be described focusing on the differences between the second embodiment and the first embodiment, and repeated descriptions will be omitted.

FIG. 10 is a perspective view of a honeycomb core 22 of a honeycomb structure 21. However, in FIG. 10, the two top plates of the honeycomb structure 21 are not shown. As shown in FIG. 10, in this embodiment, the honeycomb core 22 is formed by stacking core elements 24, which are quadrangular short hollow pipes, in a straight line in a direction orthogonal to the longitudinal direction of the core elements 24.

The manufacturing flow of the honeycomb structure 21 according to this embodiment is the same as the manufacturing flow shown in FIG. 3.

### S100: Forming Slits

FIG. 11 is a perspective view of a quadrangular long hollow pipe 25. The hollow pipe 25 is, for example, a welded pipe made of metal such as stainless steel, aluminum alloy, titanium alloy, etc. or resin, and a cross section of the hollow pipe 25 has a hollow square shape. Here, the square shape is a specific example of a rectangular shape. The rectangular shape is an example of a quadrangular shape. The hollow pipe 25 includes a first flat plate 26, a second flat plate 27, a third flat plate 28, and a fourth flat plate 29. The first flat plate 26, the second flat plate 27, the third flat plate 28, and the fourth flat plate 29 are arranged in such a way that each flat plate corresponds to each side of a square. The first flat plate 26, the second flat plate 27, the third flat plate 28, and the fourth flat plate 29 are connected to each other at vertexes of the square. The plate thickness of the hollow pipe 25, that is, the plate thickness of the first flat plate 26, the second flat plate 27, the third flat plate 28, and the fourth flat plate 29, is, for example, 1 to 3 millimeters, but is not limited to this. The first flat plate 26 and the second flat plate 27 face each other across an internal space of the hollow pipe 25. The first flat plate 26 and the second flat plate 27 are plates parallel to each other. The third flat plate 28 and the fourth flat plate 29 face each other across the internal space of the hollow pipe 25. The third flat plate 28 and the fourth flat plate 29 are plates parallel to each other.

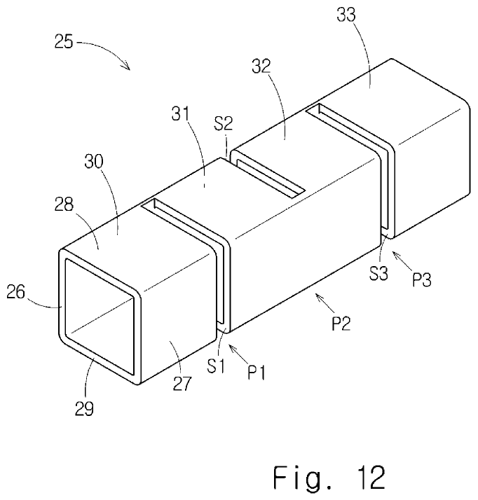

FIG. 12 shows the hollow pipe 25 in which a first slit S1, a second slit S2, and a third slit S3 are formed.

As shown in FIG. 12, the first slit S1, the second slit S2, and the third slit S3 are formed at different positions in the longitudinal direction of the hollow pipe 25.

In the longitudinal direction of the hollow pipe 25, the position where the first slit S1 is formed is defined as a first slit position P1, the position where the second slit S2 is formed is defined as a second slit position P2, and the position where the third slit S3 is formed is defined as a third slit position P3.

The first slit S1, the second slit S2, and the third slit S3 are formed in this order in the longitudinal direction of the hollow pipe 25. The first slit S1, the second slit S2, and the third slit S3 are formed so as to divide the hollow pipe 25 into four equal parts in the longitudinal direction of the hollow pipe 25.

The first slit S1 is formed in the second flat plate 27, the third flat plate 28, and the fourth flat plate 29 so as to completely cut all the flat plates except the first flat plate 26, that is, the second flat plate 27, the third flat plate 28, and the fourth flat plate 29. The first slit S1 is formed to extend in a direction orthogonal to the longitudinal direction of the hollow pipe 25. The first slit S1 is formed to extend in a U shape when viewed in the longitudinal direction of the hollow pipe 25. A slit width of the first slit S1 is typically twice the plate thickness of the hollow pipe 25. However, the slit width of the first slit S1 may be larger than twice the plate thickness of the hollow pipe 25 or as small as possible.

The second slit S2 is formed in the first flat plate 26, the third flat plate 28, and the fourth flat plate 29 so as to completely cut all the flat plates except the second flat plate 27, that is, the first flat plate 26, the third flat plate 28, and the fourth flat plate 29. The second slit S2 is formed to extend in the direction orthogonal to the longitudinal direction of the hollow pipe 25. The second slit S2 is formed to extend in a U shape when viewed in the longitudinal direction of the hollow pipe 25. A slit width of the second slit S2 is typically twice the plate thickness of the hollow pipe 25. However, the slit width of the second slit S2 may be larger than twice the plate thickness of the hollow pipe 25 or as small as possible.

The third slit S3 is formed in the second flat plate 27, the third flat plate 28, and the fourth flat plate 29 so as to completely cut all the flat plates except the first flat plate 26, that is, the second flat plate 27, the third flat plate 28, and the fourth flat plate 29. The third slit S3 is formed to extend in a direction orthogonal to the longitudinal direction of the hollow pipe 25. The third slit S3 is formed to extend in a U shape when viewed in the longitudinal direction of the hollow pipe 25. A slit width of the third slit S3 is typically twice the plate thickness of the hollow pipe 25. However, the slit width of the third slit S3 may be larger than twice the plate thickness of the hollow pipe 25 or as small as possible.

By forming the first slit S1, the second slit S2 and the third slit S3 in the hollow pipe 25 in this manner, the hollow pipe 25 is divided into a first core element 30, a second core element 31, a third core element 32 and a fourth core element 33 in the longitudinal direction of the hollow pipe 25.

The first core element 30 and the second core element 31 are divided by the first slit S1 and are connected to each other with the first flat plate 26 interposed therebetween. The second core element 31 and the third core element 32 are divided by the second slit S2 and are connected to each other with the second flat plate 27 interposed therebetween. The third core element 32 and the fourth core element 33 are divided by the third slit S3 and are connected to each other with the first flat plate 26 interposed therebetween.

### S110: Folding Back

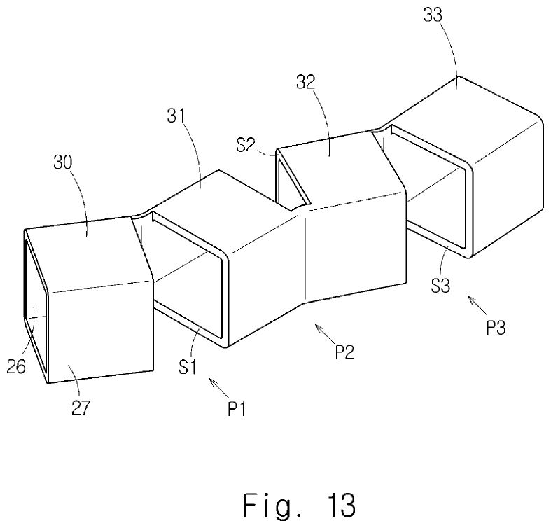

FIG. 13 shows a state in which the first flat plate 26 and the second flat plate 27 of the hollow pipe 25 are being folded back.

As shown in FIGS. 10 and 13, the first flat plate 26 is folded back at the first slit position P1. That is, the first flat plate 26 is folded back by 180 degrees at the first slit position P1 in a direction in which the slit width of the first slit S1 expands. Similarly, the second flat plate 27 is folded back at the second slit position P2. That is, the second flat plate 27 is folded back by 180 degrees at the second slit position P2 in a direction in which the slit width of the second slit S2 expands. Similarly, the first flat plate 26 is folded back at the third slit position P3. That is, the first flat plate 26 is folded back by 180 degrees at the third slit position P3 in a direction in which the slit width of the third slit S3 expands.

As a result, as shown in FIG. 10, the adjacent core elements 24 are connected to each other by the base material itself of the hollow pipe 25. That is, the first core element 30 and the second core element 31 are connected to each other with a first curved part R1 interposed therebetween, in which the first curved part R1 is formed by bending the first flat plate 26 in a U-shape at the first slit position P1.

The second core element 31 and the third core element 32 are connected to each other with a second curved part R2 interposed therebetween, in which the second curved part R2 is formed by bending the second flat plate 27 in a U-shape at the second slit position P2. The third core element 32 and the fourth core element 33 are connected to each other with a third curved part R3 interposed therebetween, in which the third curved part R3 is formed by bending the first flat plate 26 in a U-shape at the third slit position P3. Therefore, as compared with the case where the adjacent core elements 24 are connected by an adhesive, large bonding strength of the adjacent core elements 24 can be ensured. Adhesives are inferior to metals in water resistance and heat resistance. Thus, when the hollow pipe 25 is made of metal, the honeycomb core 22 excellent in the water resistance and the heat resistance is implemented by connecting the adjacent core elements 24 by the base material itself of the hollow pipe 25.

Further, as shown in FIGS. 12 and 13, by forming the first slit S1, the second slit S2, and the third slit S3 in the longitudinal direction of the hollow pipe 25 in this order, the honeycomb core 22 in which the plurality of core elements 24 are arranged in a straight line is implemented as shown in FIG. 10. The honeycomb core 22 shown in FIG. 11 can be made larger by repeatedly forming the first slit S1, the second slit S2 and the third slit S3 in this order in the hollow pipe 25 which is longer than the hollow pipe 25 shown in FIG. 10.

As shown in FIG. 10, by making the lengths of the core elements 24 equal to each other, the cut surfaces 24a of the core elements 24 are located in the same plane.

### S120: Attaching Top Plates

Attaching the two top plates to the honeycomb core 22 is as described in the first embodiment.

Since the honeycomb structure 21 shown in FIG. 10 is lightweight and highly rigid, it can be applied to various beams including columns of a vehicle, but the present disclosure is not limited to this.

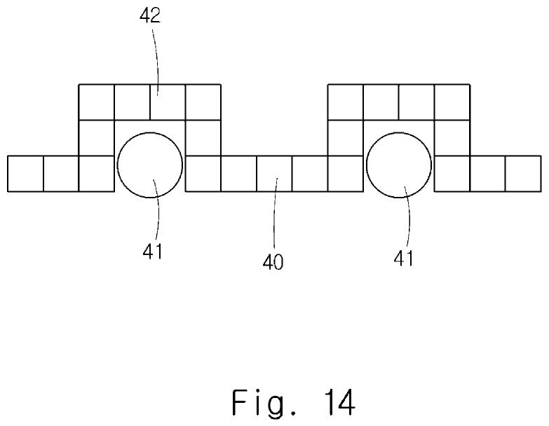

A direction in which the hollow pipe 25 is bent can be freely changed depending on which flat plate of the hollow pipe 25 is formed with a slit. Therefore, for example, as shown in FIG. 14, in addition to using the honeycomb structure 21 as a floor material 40 of a vehicle interior, the honeycomb structure 21 can be applied to a kick-up frame 42 around axles 41. In this case, a large kick angle of the kick-up frame 42 can be ensured, which consequently contributes to lowering of the floor material 40.

The second embodiment has been described above. The above embodiment has the following features.

The method for manufacturing the honeycomb structure 21 (frame) from the quadrangular hollow pipe 25 composed of the first flat plate 26, the second flat plate 27, the third flat plate 28, and the fourth flat plate 29 includes the following steps.

As shown in FIG. 12, the method for manufacturing the honeycomb structure 21 includes a step of forming the first slit S1 in the hollow pipe 25 so as to cut all the flat plates except the first flat plate 26 (i.e., the second plate 27, the third flat plate 28, and the fourth flat plate 29), and forming the second slit S2 in the hollow pipe 25 so as to cut all the flat plates except the second flat plate 27 (i.e., the first plate 26, the third plate 28, and the fourth flat plate 29) at the position different from the first slit position P1 (the position of the first slit S1) in the longitudinal direction of the hollow pipe 25.

The method for manufacturing the honeycomb structure 21 further includes a step of folding back the first flat plate 26 at the first slit position P1, and folding back the second flat plate 27 at the second slit position P2 (the position of the second slit S2).

According to the above method, since the plurality of core elements 24 divided by the first slit S1 and the second slit S2 are connected to each other by the base material itself of the hollow pipe 25, the honeycomb structure 21 excellent in the water resistance and the heat resistance is implemented as compared with the case where the core elements 24 are connected to each other by an adhesive.

In the step of forming slits, the third slit S3 is further formed in the hollow pipe 25 at the position different from the first slit position P1 and the second slit position P2 in the longitudinal direction so as to cut all the flat plates except the first flat plate 26 (i.e., the second plate 27, the third flat plate 28, and the fourth flat plate 29). In the step of folding back, the first flat plate 26 is further folded back at the third slit position P3 (the position of the third slit S3).

According to the above method, as shown in FIG. 10, the honeycomb structure 21 in which the plurality of core elements 24 divided by the first slit S1, the second slit S2, and the third slit S3 are arranged in a straight line is implemented.

### Third Embodiment

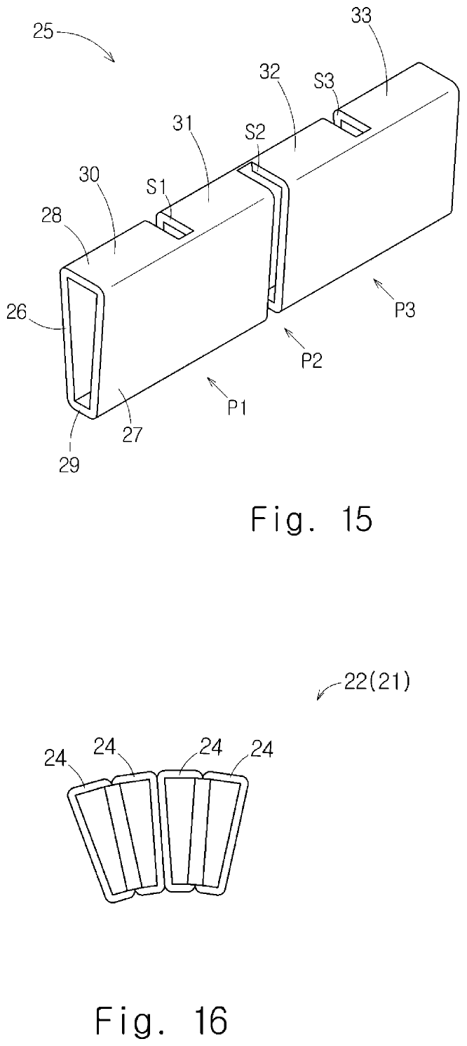

A third embodiment will be described below with reference to FIGS. 15 and 16. Hereinafter, this embodiment will be described focusing on the differences between the third embodiment the second embodiment, and repeated descriptions will be omitted.

In the second embodiment, as shown in FIG. 11, the hollow pipe 25 having a square cross-sectional shape was used to manufacture the honeycomb structure 21. In contrast, in this embodiment, as shown in FIG. 15, the honeycomb structure 21 is manufactured by using the hollow pipe 25 having an isosceles trapezoidal cross-sectional shape. The isosceles trapezoidal shape is a specific example of the trapezoidal shape.

Specifically, a first flat plate 26 and a second flat plate 27 correspond to legs of the trapezoidal cross section of the hollow pipe 25. The third flat plate 28 and the fourth flat plate 29 correspond to the upper and lower sides of the trapezoidal cross section of the hollow pipe 25, respectively.

By using the hollow pipe 25 having an isosceles trapezoidal cross section, an arched honeycomb core 22 as shown in FIG. 16 is implemented. The arched honeycomb core 22 can be applied to a suspension member on the rear wheel side.

In addition, the arched honeycomb core 22 can be applied to beams in which an arcuate shape is desired, such as fenders and rules. Furthermore, the arched honeycomb core 22 can also be applied to beams of structures such as bridges and houses.

From the disclosure thus described, it will be obvious that the embodiments of the disclosure may be varied in many ways. Such modified examples are not to be regarded as a departure from the spirit and scope of the disclosure, and all such modified examples as would be obvious to one skilled in the art are intended for inclusion within the scope of the following claims.

What is claimed is:

1. A method for manufacturing a frame from an N-polygonal shape (N is a natural number greater than or equal to 3) hollow pipe composed of first to N-th flat plates, the method comprising:
forming a first slit in the hollow pipe so as to cut all the flat plates except the first plate and forming a second slit in the hollow pipe at a position different from a position of the first slit in a longitudinal direction of the hollow pipe so as to cut all the flat plates except the second flat plate; and
folding back the first plate at the position of the first slit and folding back the second flat plate at the position of the second slit.

2. The method according to claim 1, wherein
the N is 3, and the hollow pipe is triangular.

3. The method according to claim 2, further comprising:
forming a third slit in the hollow pipe so as to cut all the flat plates except the third flat plate at a position different from the position of the first slit and the position of the second slit in the longitudinal direction; and
folding back the third flat plate at the position of the third slit.

4. The method according to claim 1, wherein
the N is 4, and the hollow pipe is quadrangular.

5. The method according to claim 4, wherein
the first flat plate and the second flat plate face each other across an internal space of the hollow pipe.

6. The method according to claim 5, further comprising:
forming a third slit in the hollow pipe so as to cut all the flat plates except the first flat plate at a position different from the position of the first slit and the position of the second slit in the longitudinal direction; and
folding back the first flat plate at the position of the third slit.

7. The method according to claim 4, wherein
the hollow pipe is rectangular.

8. The method according to claim 4, wherein
the hollow pipe has a trapezoidal shape, and
the first flat plate and the second flat plate correspond to legs of the hollow pipe.

9. The method according to claim 8, wherein
the hollow pipe is an isosceles trapezoid.

10. The method according to claim 1, wherein
the hollow pipe is made of metal or resin.

11. The method according to claim 1, wherein
the frame is a strength part, a suspension part of an automobile, a chassis part, or a ladder frame.
